(19) United States
(12) Patent Application Publication
(10) Pub. No.: US 2010/0280892 A1
(43) Pub. Date: Nov. 4, 2010

(54) Method and system for targeted offers to mobile users

(75) Inventors: Huseyin Uzunalioglu, Bridgewater, NJ (US); Kenneth C. Budka, Marlboro, NJ (US)

Correspondence Address: HARNESS, DICKEY & PIERCE, P.L.C., P.O. BOX 8910, RESTON, VA, 20195, US

(73) Assignee: ALCATEL-LUCENT USA INC.

(21) Appl. No.: 12/453,136

(22) Filed: Apr. 30, 2009

(51) Int. Cl. G06Q 30/00; G06Q 50/00; G06N 5/02

(52) U.S. Cl. 705/14.13; 706/52

(57) ABSTRACT

A system for targeted offers to at least one mobile user includes a data collection system configured to collect information relating to the at least one mobile user's interests, a profiling engine configured to profile the at least one mobile user according to a plurality of classification groups based on the collected information of the data collection system, a matching engine configured to map the at least one mobile user profile received from the profiling engine to at least one service profile, and an offer manager configured to offer at least one service to the at least one mobile user based on the mapping received from the matching engine and a trigger received from the data collection system.

### BACKGROUND

1. Field

One or more example embodiments relate to a wireless communication network, for example, to a method or system for targeted offers to mobile users in the wireless communication network.

2. Description of the Related Art

Mobile Network Operators (MNOs) seek to increase their Average Revenue Per User (ARPU) by selling new services, new applications, and/or upgrades for existing services/applications to their mobile users or customers. Advertising and promotions are used to inform the mobile users about these services and applications. Providing free application or service trials is one such example used to increase the mobile user's awareness of the service or application as well as increase the mobile user's interest in paying for the additional service or application. MNOs generally offer free trials in a model where if the mobile user subscribes, the application or service is free for a limited time, such as the first month of use.

Multiple difficulties generally arise when the free trials are offered to the mobile users. First, offering the trial itself may irritate the mobile user if the offered trial is of a subject matter that does not interest the mobile user. Further, repeatedly offering the trial may increasingly irritate the mobile user. Secondly, even if the mobile user would be interested in the offered trial, the trial may be offered during a time period when the mobile user is otherwise occupied with another activity, and therefore the mobile user may not subscribe to the free trial. Finally, blindly offering free trials to a large number of mobile users may result in congestion problems in the network as the MNO may not be able to estimate how many mobile users would be interested in the free trial. For example, if the number of mobile users accepting the offer is unexpectedly large, the resulting network congestion may degrade a performance of the service or application, thus causing mobile user frustration and leading to an outcome that is counter to an intended outcome of the free trial.

Another example used to inform the mobile users of the application or service is using advertisements or marketing calls. Advertising represents a pull model, where the mobile user initiates contact with the MNOs, such as by calling a phone number or visiting an internet web page listed in the advertisement to subscribe to the service or application. Marketing calls represent the push model, where the MNOs initiate contact, such as by calling the mobile user to encourage the mobile user to subscribe to the service or application.

Thus, service or application offers are not targeted to specific mobile users based on the mobile user's interests. Furthermore, marketing calls are generally regarded as spam by the mobile users and may be received at times inconvenient to the mobile users, thus further reducing the likelihood that the mobile user will accept the offer. Also, the service or application offers are submitted to the mobile users by the MNOs regardless of the network conditions. Therefore, if the application or service is offered when the network conditions are not suitable for providing a high quality of experience to the mobile user, and the mobile user attempts to use the application or service trial at this time, this may lead to poor performance of the application or service and a disappointing experience for the mobile user.

### SUMMARY

Example embodiments relate to device and method of targeting offers to mobile users.

According to an example embodiment, a system for targeted offers to at least one mobile user includes a data collection system configured to collect information relating to the at least one mobile user's interests, a profiling engine configured to profile the at least one mobile user according to a plurality of classification groups based on the collected information of the data collection system, a matching engine configured to map the at least one mobile user profile received from the profiling engine to at least one service/application profile, and an offer manager configured to offer at least one service/application to the at least one mobile user based on the mapping received from the matching engine and a trigger received from the data collection system.

According to another example embodiment, a method for targeted offers to at least one mobile user includes collecting information relating to the at least one mobile user's interests, profiling the at least one mobile user according to a plurality of classification groups based on the collected information of the data collection system, mapping the at least one mobile user profile received from the profiling engine to at least one service/application profile, and offering the at least one service/application to the at least one mobile user based on the mapping and a trigger received from the collecting.

### BRIEF DESCRIPTION

Example embodiments will become more fully understood from the detailed description given herein below and the accompanying drawings, wherein like elements are represented by like reference numerals, which are given by way of illustration only and thus are not limiting of the present invention, and wherein:

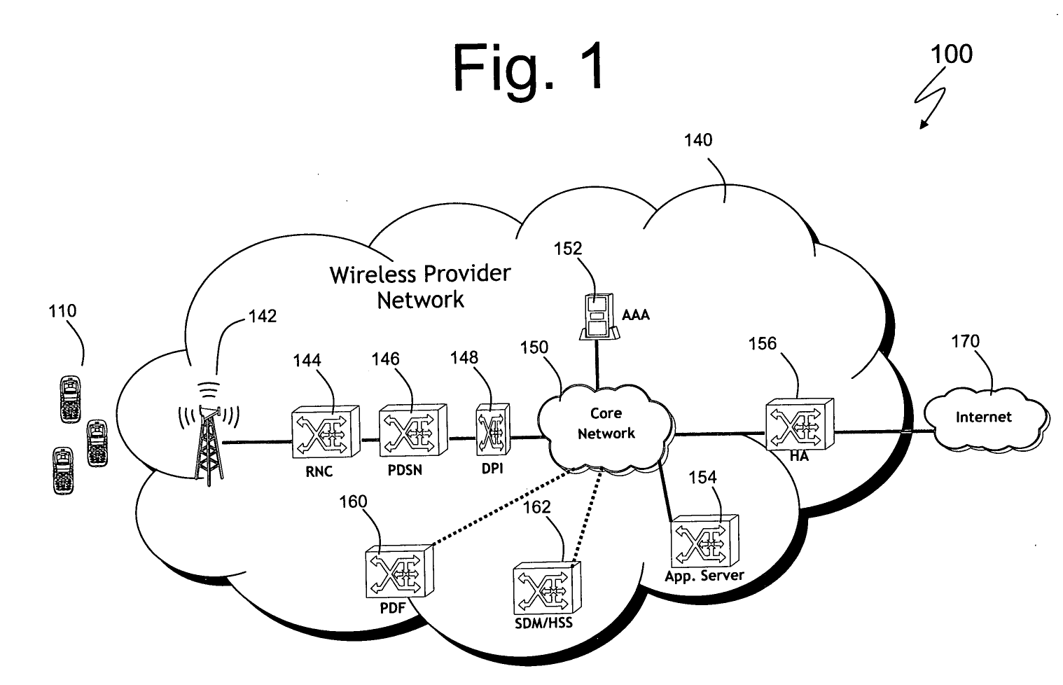

FIG. 1 illustrates a portion of a wireless telecommunications system according to an example embodiment;

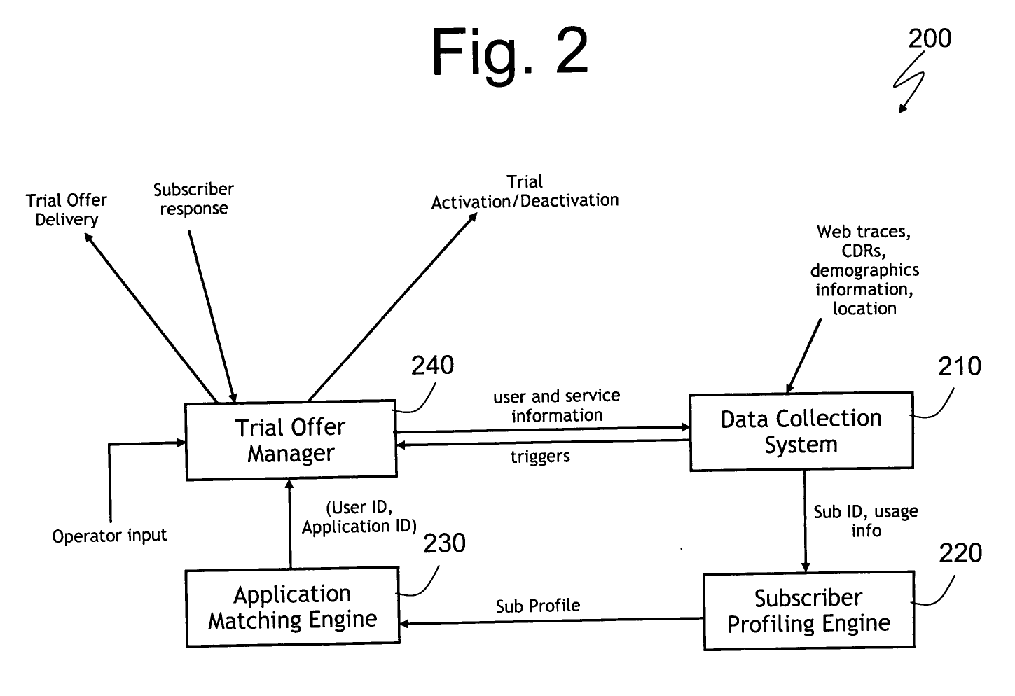

FIG. 2 is a block diagram of a system for targeted offers to mobile users according to an example embodiment;

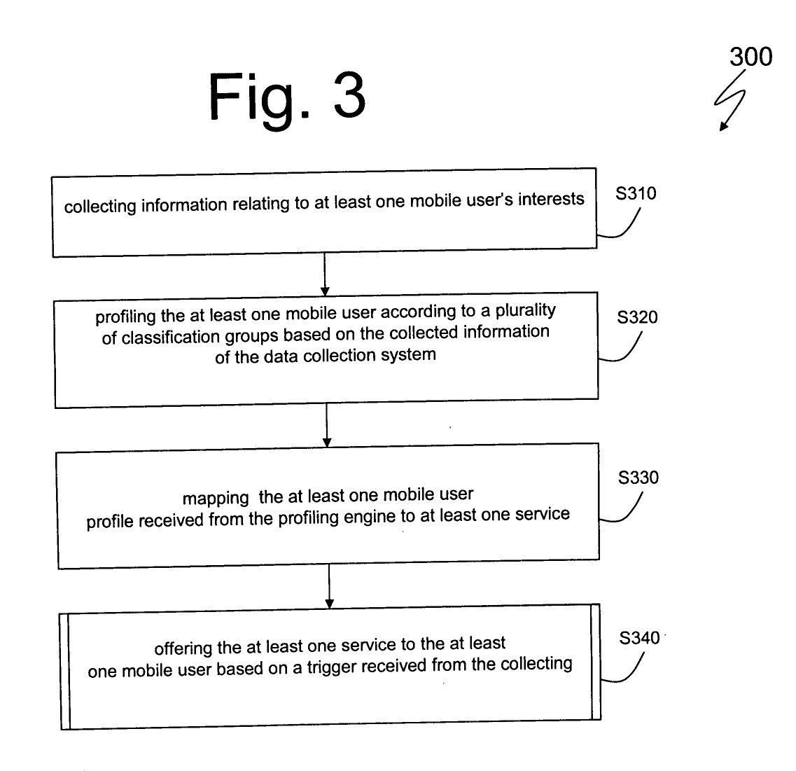

FIG. 3 illustrates a method of targeting offers to mobile users according to an example embodiment;

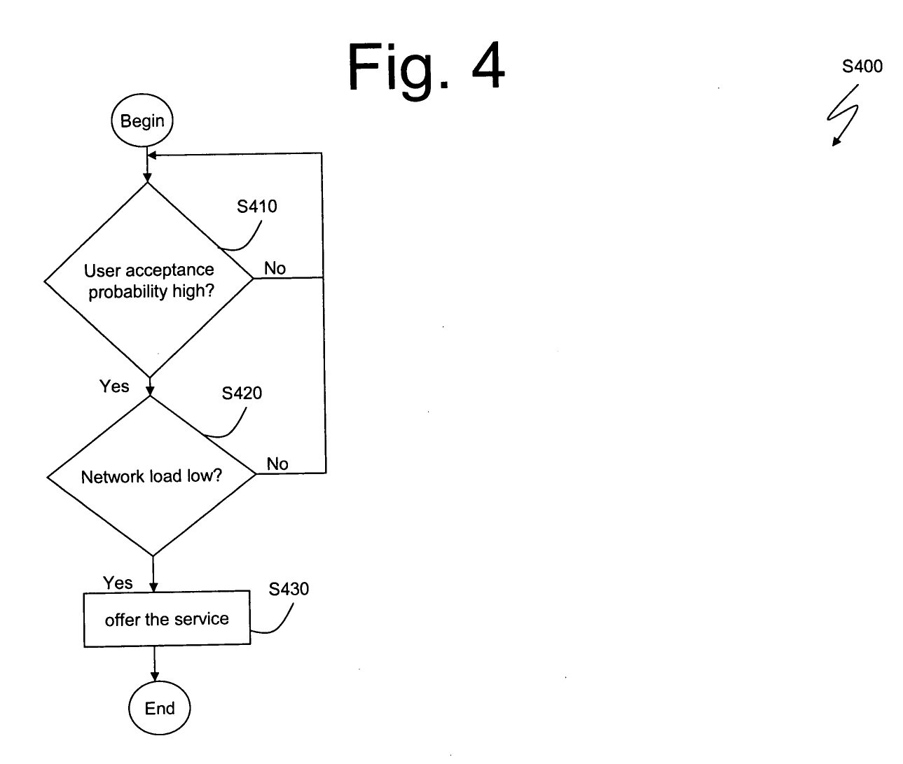

FIG. 4 illustrates an embodiment of step S340 in the method of FIG. 3; and

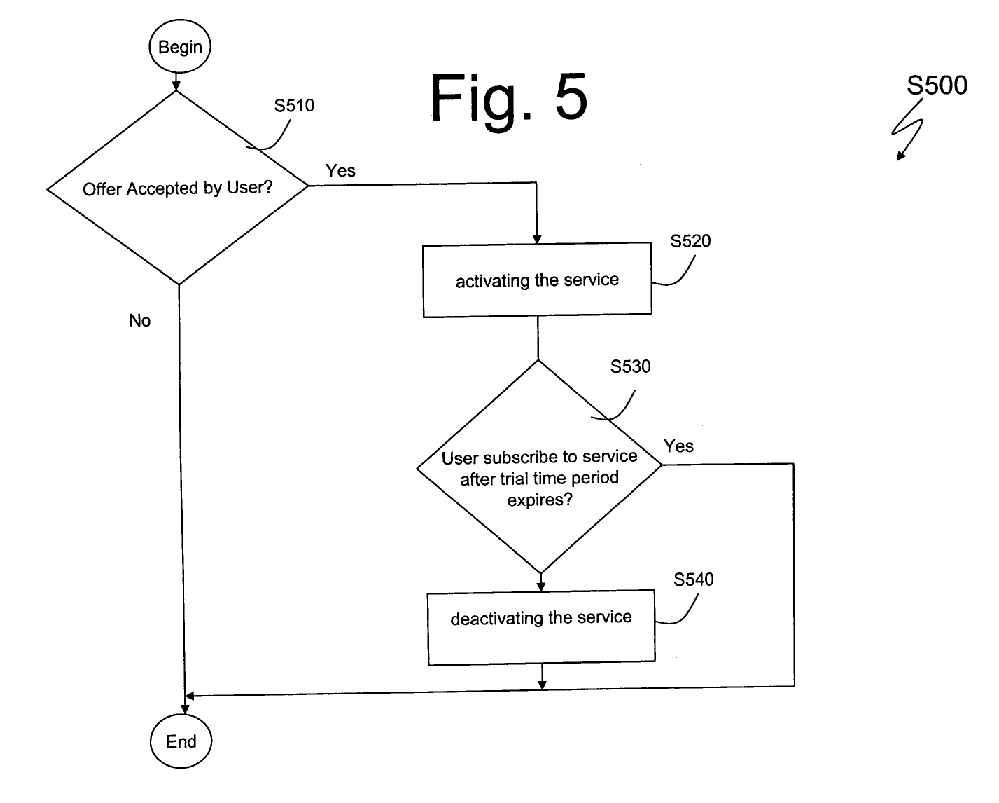

FIG. 5 illustrates a method of initiating subscriptions after the targeted offers are accepted by the mobile users according to an example embodiment.

### DETAILED DESCRIPTION

Various example embodiments will now be described more fully with reference to the accompanying drawings.

Specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent”, etc.).

Unless otherwise defined, all terms (including technical and scientific terms) used herein have the same meaning as commonly understood by one of ordinary skill in the art to which example embodiments belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

It should also be noted that in some alternative implementations, the functions/acts noted may occur out of the order noted in the FIGS. For example, two FIGS. shown in succession may in fact be executed substantially concurrently or may sometimes be executed in the reverse order, depending upon the functionality/acts involved.

Specific details are given in the following description to provide a thorough understanding of example embodiments. However, it will be understood by one of ordinary skill in the art that example embodiments may be practiced without these specific details. For example, systems may be shown in block diagrams in order not to obscure example embodiments in unnecessary detail. In other instances, well-known processes, structures and techniques may be shown without unnecessary detail in order to avoid obscuring example embodiments.

Also, it is noted that example embodiments may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process may be terminated when its operations are completed, but could have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As used herein, the term “mobile” may be considered synonymous to, and may hereafter be occasionally referred to, as a mobile unit, mobile station, mobile user, user equipment (UE), subscriber, user, remote station, access terminal, receiver, etc., and may describe a remote user of wireless resources in a wireless communication network. The term “base station” may be considered synonymous to and/or referred to as a base transceiver station (BTS), base station (BS), Node B, etc. and may describe equipment that provides data and/or voice connectivity between a network and one or more mobile users.

As is well-known in the art, each of a mobile and a base station may have transmission and reception capabilities. Transmission from the base station to the mobile is referred to as downlink or forward link communication. Transmission from the mobile to the base station is referred to as uplink or reverse link communication.

FIG. 1 illustrates a portion of a wireless telecommunications system 100 according to an example embodiment. As shown, the system 100 includes a plurality of mobiles 110 and a wireless provider network 140. While the wireless provider network 140 shown in FIG. 1 is in reference to a Code division multiple access (CDMA) network, example embodiments may apply to other networks as well, such as Universal Mobile Telecommunications System (UMTS), Long Term Evolution (LTE), Global System for Mobile communications (GSM), and Worldwide Interoperability for Microwave Access (WiMAX) networks. The wireless provider network 140 includes at least one base station (BS) 142, at least one Radio Network Controller (RNC) 144, a Packet Data Serving Node (PDSN) 146, a Deep Packet Inspection unit (DPI) 148, a core network 150, an Authentication, Authorization, and Accounting (AAA) server 152, an Application Server 154, and a Home Agent 156. Optionally, the wireless provider network 140 may also include a Policy Decision Function unit (PDF) 160 and a Subscriber Data Manager (SDM) 162. The SDM 162 may also be referred to as a Home Subscriber Server (HSS).

The wireless provider network 100 may represent a wide service area belonging to a particular service provider. The RNC 144 connects to the plurality of mobiles through the at least one BS 142.

The RNC 144 may be communicatively coupled to the one or more BSs 142 by any of a variety of wired and/or wireless links. Signals passed between the RNC 144 and the one or more BSs 142 may pass through one or more other devices (not shown), such as, routers, switches, networks or the like. The RNC 144 also serves as an interface between the plurality of mobiles 110, and other wireless telecommunications systems, service nodes, gateways, or any other wireless or terrestrial network or network device, such as a public internet network 170. Further, the RNC 144 may perform other tasks such as switching and/or provisioning services of the mobile 110 and/or 3G data network interfaces, such as, in an Evolution-Data Optimized (EV-DO) network.

The PDSN 146 acts as a gateway between the RNC and the core network 150. As will be explained in further detail below with respect to FIG. 2, the DPI 148 is located within the wireless network 140. Traffic between the mobile 110 and the public internet network 170 passes through the DPI 148. The DPI 148 may identify and/or analyze at least one of web sites visited, amount of time spent, information gathered, etc., by a mobile user based on analyzing the mobile user's packet data. While the DPI 148 is shown in FIG. 1 next to the PDSN 146, the DPI may also be placed at another point between the path of the mobile 110 and the public internet network 170, as well as be internal to one of the components, such as the PDSN 146.

The core network 150, which is located between the DPI 148 and the HA 156, provides internet protocol (IP) packet transport services. For example, the core network 150 may forward the packet data to a next point in the wireless provider network 140, and connects to the DPI 148, AAA server 152, Application Server 154 and the HA 156.

The AAA server 152 handles mobile user requests for access to network resources and provides authentication, authorization, and accounting (AAA) services. The Application Server 154 stores and manages the applications and services being offered to the mobile users. The terms application(s) and service(s) may be used interchangeably.

The HA 156 is a router within the mobile's 110 wireless provider network 140 that maintains information about the mobile's 110 current location and uses tunneling mechanisms to forward Internet traffic so that the mobile's 110 IP address does not have to be changed when the mobile 110 connects from a different location. The HA 156 may connect to the core network 150 and to the public internet network 170.

The core network 150 may also optionally connect to the PDF 160 and SPM 162. The PDF 160 may control traffic entering the wireless provider network 140 by allocating or denying IP resources. The SDM 162 may store and manage subscriber data of the mobile users.

FIG. 2 is a block diagram of a system for targeted offers 200 to the mobile users according to an example embodiment. As shown, the system 200 includes a Data Collection System (DCS) 210, a Subscriber Profiling Engine (SPE) 220, an Application Matching Engine (AME) 230, and a Trial Offer Manager (TOM) 240. FIG. 2 illustrates a functional view, where the DCS 210, SPE 220, AME 230 and TOM 240 are functional units that may be implemented in a variety of ways within a variety of networks.

For example, the targeted offers system 200 of FIG. 2 may be implemented in conjunction with the wireless telecommunication system 100 shown in FIG. 1. In addition, the DCS 210, SPE 220, AME 230 and TOM 240 may be implemented within the wireless provider network 140 through one or more individual servers (not shown) or inside existing components such as at least one of the DPI 148 and Application Server 154. Alternatively, the targeted offers system 200 may be also implemented in at least one of the PDSN 146, core network 150, AAA server 152, PDF 160, and SDM 162.

The system 200 is configured to determine the mobile users whose interests are relevant to a marketed service. In general, the system 200 seeks to map a set of applications to a set of mobile users. For example, for each service, the system 200 may seek to determine a set of mobile users to be targeted for free trial service offers. One example of realizing this mapping is to at least one of observe, collect and analyze the data generated or terminated at mobiles 110 and analyze the data to determine interests of each of the mobile users.

For each marketed service, there is a set of related network activities. The DCS 210 seeks to capture these related activities and identify the mobile users performing them. For example, if the system 200 seeks to target mobile users for only a single service offer, the DCS 210 may detect the IDs of the mobile users who performed activities related to the single service offer.

Given a set of services to be marketed, there is a broader set of network activities that point to the mobile users' interest in the marketed services.

Referring to FIGS. 1 and 2, the DPI 148 may aid the DCS 210 to capture the mobile users performing a set of related activities. For example, the DPI 148 may pass information about the mobile users and their network usage behavior to the DCS 210.

The DCS 210 may be configured to collect information relating to the mobile user's interests. For example the DCS 210 may receive web traces from the DPI 148, Call Detail Records (CDRs) from a billing system (not shown), and demographics information from an external database (not shown). The CDRs are summary records describing a subscriber's usage of the network resources. As such, the CDRs are often used for billing purposes but also may be used to profile the mobile users as information relating to subscriber activity may be determined from the CDRs. For example, the CDRs may relate to the mobile user's voice and/or data services usage. Demographics information may include subscriber age, gender, location, etc.

The DCS 210 may also receive information from the mobile 110 through a software agent (not shown) within the mobile 110. For example, a software agent installed in the mobile 110 may collect information about the mobile relating to web sites visited, services accessed, a duration the websites are visited, a duration the services are accessed by the mobile users, the location of the mobile user, etc. Further, the DCS 210 may also collect information to help measure the effectiveness of the offer, e.g., data on trials offered to the mobile users, such as the application offered, whether the mobile user accepted the trial offer and the conditions under which the trial was accepted, such as time of day, location, or trigger, and information related to whether the mobile user decided to purchase the service after the trial, such as offer price. This information may be used, for example, to further refine the algorithms used to present offers to the mobile users, alter pricing plans to increase an acceptance rate of the offer, etc.

Information retrieved from deep inspection into the packet through the DPI 148 or the software agent of the mobile 110 may not always be necessary to determine mobile user interests. For example, simple packet header analysis may be sufficient to detect certain applications. For instance, to detect the mobile user browsing a website, the DCS 210, through the DPI 148, may detect a DNS query from the mobile user for the website by inspecting only a header of the packet and not a body or payload of the packet. The IP address provided by the DNS query may be then used to detect packets going to or coming from the website. In another example of determining mobile user interest, the DCS 210 may detect keyword searches of the mobile user that are related to a specific service. For example, if the DCS 210 is set to collect information relating to online gaming of the mobile users, the DPI 148 may detect DNS queries to well known gaming web sites and may also capture search requests containing keywords such as “gaming”, “poker”, “tetris,” etc. Mobile user interest may also be determined by the mobile user's calling records.

The SPE 220 is configured to profile the mobile users according to a plurality of classification groups based on the collected information of the DCS 210. The plurality of classification groups may include groups such as video, music, sports, news, social networking, etc. The received collected information of the DCS 210 may be classified to at least one of plurality of classification groups based on at least one classification rule for the mobile users' profiles. The at least one classification rule may be a simple metric such as tallying each visit to a website to one of the plurality of classification groups based on a type of the website. For example, if the mobile user visits a website that streams video, a point value may be added to the video group of the mobile user's profile. In addition, the at least one classification rule may use a more complex metric such that weighting behavior of the mobile user over a period of time according to a algorithm taking into account a plurality of factors. For example, one of the plurality of factors may include previous acceptance rates of at least one of service offers and service subscriptions by the mobile user. The developed mobile user profiles of the SPE 220 are sent to the AME 230.

The AME 230 is configured to map the mobile user profiles received from the SPE 220 to at least one service profile. The mapping includes pairing each of the mobile users to at least one of the services. The mobile user profiles indicate the mobile user's level of interest in one or more target areas. Similarly, each service to be marketed includes a service profile indicating the service's compatibility to the one or more target areas. Thus, the AME 230 compares the mobile user profile information and the service profile to determine which trial service to offer to which mobile user. For example, the AME 230 may select the mobile users having the highest levels of interest for a particular trial service offer. This mapping or pairing of mobile user and service information is sent to the TOM 240.

The TOM 240 is configured to send trial offers to the one or more targeted mobile users based on the mapping of the AME 230 and a trigger received from the DCS 210, and to receive the mobile user's response to the offered trial service. If the mobile user accepts the offered trial service, the trial service is initiated by the TOM 240 by communicating with at least one of the PDSN 146, PDF 160, SDM 162, and Application Server 154, depending on a type of the offered service. The TOM 240 is also configured to send mobile user and/or service information to the DCS 210 in order to aid the DCS 210 in collecting additional or more specific information about the mobile user's interests. Triggers and mobile user and service information may also be received manually by the TOM 240 from an operator, where a trigger may be a signal received in response to one or more events occurring or not occurring, such as mobile user acceptance probability being high and/or network load being low. The use of triggers are further discussed with respect to FIG. 4 below.

FIG. 3 illustrates a method 300 of targeting offers to mobile users according to an example embodiment. Referring to FIGS. 2 and 3, at S310, the DCS 210 collects information relating to the at least one mobile user's interests. At S320, the SPE 220 profiles the at least one mobile user according to a plurality of classification groups based on the collected information of the data collection system.

Alternatively, a trial service may be offered to the mobile user as soon as the mobile user is detected to perform a related task without explicitly profiling the at least one mobile user at S320. Nonetheless, applying the profiling at S320 may ensure that only the mobile users with a genuine interest for the trial are targeted. Otherwise, at least one of the mobile users may be repeatedly sent offers that the at least one mobile user is not likely accept, thus irritating the at least one mobile user and unnecessarily increasing network costs.

At S330, the AME 230 maps the at least one mobile user profile received from the profiling engine to at least one service. At S340, the TOM 240 offers the at least one service to the at least one mobile user based on a trigger received from the collecting at S310.

The trial service may be offered by the TOM 240 at S340 by at least one of a Short Message Service (SMS) message and a pop-up window transmitted to the mobile user's mobile 110. The SMS may include the name of the service and the details of the offer and its limited nature, e.g., “Free access to our Video Portal or Gaming Service for the next hour. Respond within 5 minutes to claim.” Alternatively, Multimedia Messaging Service (MMS) and Wireless Application Protocol (WAP) push may also be used to offer the trial service.

The pop-up window or another type of similar alert may appear on a screen of the mobile user's mobile 110 based on an agent program written and deployed in the mobile 110. The agent may listens to a proprietary port number for an incoming message for a trial service by the TOM 240 at S340. Upon receiving the message, the agent displays the pop-up window or alert appears on the mobile user's screen.

SMS messages are generally supported in all phones and thus the SMS-based offer submission may be easier to implement while the agent method may require implementation of the agent software.

FIG. 4 illustrates an embodiment of step S340 in the method of FIG. 3. As described above in FIGS. 2 and 3, the method 300 seeks to target at least one of a plurality of mobile users for the trial service based on the at least one mobile user's interest in the trial service. Subscriber profiling at S310 and S320 may be needed to determine which of the plurality of mobile users are likely to be interested a specific marketed service. For example, a mobile user who watches videos from a website on the mobile 110 is likely to be interested in a MNO-hosted video service or a service that provides higher quality video from that website through better Quality of Service (QoS) or higher access speeds. Once the mobile user's interests are known through the DCS 210 and the SPE 220, the AME 230 may decide which service should be offered to the mobile user for a free-trial.

However, as shown in the method 400 in FIG. 4, the trial service is only offered when at least one of when mobile user acceptance probability is high and network load is low such that offering the trial service will not degrade performance of the network. At S410, the TOM 240 determines if the mobile user acceptance probability is high. For example, the mobile user acceptance probability may be high if the trial offer is submitted to the mobile user when the mobile user is performing an activity related to the trial service on the mobile 110. Thus, the trial service may be offered to the mobile user at a moment when the mobile user is in a mindset more likely to accept the offered trial service. If the mobile user acceptance probability is high, the TOM 240 then determines if the network load is low at S420. The network load may considered sufficiently low only if a portion of the network that will carry the trial service traffic has sufficient capacity for the additional mobile user.

If the network is congested or the network load is high and not low at a current time period, the trial service may be offered at a another time period when the mobile user is performing the related activity and the network load is low. If the network load is low, the TOM 240 offers the service to the mobile user at S430. Step S420 may be performed before or at a same time as step S410. In addition, step S420 may also be skipped if the application or service is not sensitive to network load. For example, step S420 may be skipped for a calendar application but performed for a video service, which is sensitive to network load.

Also, information relating to the mobile user acceptance rate, the network load and network signaling events may be received from the DCS 210 as a trigger to the TOM 240 based on mobile user information collected by the DCS 210. The networking signaling events may relate to the mobile phone powering on, attachment to a data network, roaming, etc. For example, when the mobile 110 is powered on, the mobile 110 may communicate with the wireless provider network 140 and undergo an authentication process. As the authentication process is occurring, the DCS 210 may detect that the mobile 110 is becoming active and send a trigger to the TOM 240 in order to promptly send an offer. This offer may further depend on the location of the mobile 110. For instance, if the mobile user was located near an airport or airplane, it may be determined that the mobile user is traveling and an application relating to travel or tourism may be offered by the TOM 240. The application relating to travel or tourism may also be offered if the mobile user is detected as roaming.

When the mobile 110 is powered on, the mobile 110 may not be necessarily using the public internet network 170. When the mobile user starts a data application, the mobile 110 may attach to the public internet network 170, which may act as a trigger indicating that the mobile user is actively using the data services, so that the application may be offered by the TOM 240.

If the mobile user accepts the trial service, and starts using the service upon activation, additional traffic will be generated in the wireless provider network 140, which may lead to congestion in the wireless or wireline parts of the wireless provider network 140. Thus, the trial service is offered at S430 only if it is known at S420 that the trial service will not lead to congestion problems in the wireless provider network 140. Information about network resource availability may be based on the data collected by the DPI 148 and/or the DCS 210. In addition, simplified metrics may also be used to determine the network load such as a time-of-the-day, because network usage generally varies greatly based on the time of day. For example, a metric may be used that allows for offering trial service during hours of the day when the network load is generally low and the DPI 148 detects that the targeted mobile user is engaged in an activity related to the trial service.

For example, in an example embodiment, if a targeted mobile user is classified as interested in video services, a limited trial offer for the MNO's video service will be submitted to the mobile user whenever the mobile user is performing an activity related to video services and the network load is low.

FIG. 5 illustrates a method of initiating subscriptions after the targeted offers are accepted by the mobile users according to an example embodiment. Referring to FIG. 5, once the trial service offer is accepted by the mobile user at S510, a limited trial service is activated at that moment at S520.

Service activation at S520 may differ based on the method used for sending the offer. For the SMS offer, the mobile user responds back to accept the offer. Upon receiving this response, the system 200 initiates the service the limited-time service activation. For the agent-based offer, the mobile user accepts the offer through an action on the agent software, which, then, initiates the limited-time service activation. For either the SMS or agent-based offer, the mobile user may also respond in a manner to show interest for a future trial of the service. Initiating of service activation may involve interactions with various application servers and network entities as well as updates in multiple database entities depending on the type of service.

The mobile user then may utilize the service for free until a trial time period expires. Upon termination or expiration of the trial time period, the mobile user may be requested or asked to subscribe to the activated service for a fee or purchase a service contract at S530. Alternatively, the subscription to the activated service may be offered for free to the subscriber. The free subscription may supported by advertising. Similar to the trial service offer, the subscription offer may also be submitted to the mobile user via a SMS, MMS, WAP push or agent-based offer method. If the mobile user decides to subscribe to the activated service, the service remains activated and the system 200 shown in FIG. 2 interacts with the necessary network entities of FIG. 1 to initiate a paid subscription of the activated service. Otherwise, the activated service is deactivated if the mobile user does not subscribe to the activated service at S540. However, the mobile user may be offered a trial for the same service at a later time period.

In one example, the MNO may seek to conduct automated market research for a new service that the MNO is planning to offer.

Mobile user interest, pricing strategies, and an effect on the network for new service may be unknown to the MNO. Therefore, the MNO may collect such information through a limited-trial service according to example embodiments.

For example, at S530, different mobile users may be offered the service contracts at varying prices. Based on the mobile user's reaction to the subscription offer, the MNO may determine mobile user interest and pricing policies for the new services. Moreover, the MNO may also collect information through the DCS 210 about the usage patterns for the new application to help understand and plan for the network capacity needs.

While example embodiments are described in relation to a wireless communication system, example embodiments are not limited thereto, and may be used in relation to various types of data networks.

All of the above described functions may be readily carried out by special or general purpose digital information processing devices acting under appropriate instructions embodied, e.g., in software, firmware, or hardware programming.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the invention, and all such modifications are intended to be included within the scope of the invention.

I/we claim:

1. A system for targeted offers to at least one mobile user, comprising:
a data collection system configured to collect information relating to the at least one mobile user's interests;
a profiling engine configured to profile the at least one mobile user according to a plurality of classification groups based on the collected information of the data collection system;
a matching engine configured to map the at least one mobile user profile received from the profiling engine to at least one service profile; and
an offer manager configured to offer at least one service to the at least one mobile user based on the mapping received from the matching engine and a trigger received from the data collection system.

2. The system of claim 1, wherein,
the data collection system is configured to send the trigger based on information relating to at least one of user acceptance probability, network load, and network signaling events, where the networking signaling events relate to at least one of powering on, attachment to a data network, and roaming, and
the data collection system is further configured to collect information relating to an acceptance rate of the at least one service offered to the at least one mobile user.

3. The system of claim 2, wherein,
the offer manager offers the at least one service when the mobile user acceptance probability is high and the network load is low such that offering the service will not degrade performance of a network,
the offer manager determines the network load is low if a portion of the network that will carry service traffic has sufficient capacity for an additional mobile user, and
the offer manager determines the mobile user acceptance probability is high when the at least one mobile user is performing an activity related to the at least one service.

4. The system of claim 3, wherein the offer manager offers the at least one service at a another time period when the mobile user acceptance probability is high and the network load is low, if at least one of the network load is not low and the mobile user acceptance probability is not high at a current time period.

5. The system of claim 1, wherein,
the offer manager activates the at least one service if the at least one offered service is accepted by the at least one mobile user,
the offer manager requests the at least one mobile user to subscribe to the at least one activated service for a fee after a trial time period expires, and
the offer manager deactivates the at least one activated service if the at least one mobile user does not subscribe to the at least one activated service.

6. The system of claim 1, wherein the matching engine pairs each of the at least one mobile users to the at least one of the services based on the at least one mobile user profiles and the at least one service profiles, where the at least one mobile user profiles indicate at least one mobile user's level of interest in one or more target areas and the at least one service profile indicates the at least one service's compatibility to the one or more target areas.

7. The system of claim 1, further comprising:
a deep packet inspection unit (DPI) configured to analyze data packets sent between the at least one mobile user and a public internet network to send information about the analyzed data packets to the data collection system, wherein
the data collection system collects information relating to at least one of web traces, web sites visited, keyword searches, a duration the websites are visited, a duration the services are accessed are visited, a duration the services are accessed, calling records, Call Detail Records (CDRs), and demographics information, and
the web traces are collected from the DPI, the CDRs are collected from at least one of the DPI and a billing system, and the demographics information is collected from an external database, with the CDRs including summary records describing the at least one mobile user's usage of network resources and the demographics information including at least one of subscriber age, gender and location of the at least one mobile user.

8. The system of claim 1, wherein the system is configured to conduct market research for a new service, where the market research includes gauging at least one of user interest, pricing strategies, usage patterns, and an effect on the network of the new service, with the pricing strategies including offering a service contract at varying prices to the users.

9. The system of claim 1, wherein,
the profiling engine having the plurality of classification groups includes at least one of video, music, sports, news, and social networking groups,
the profiling engine classifies the received collected information according to one of the plurality of classification groups based on at least one classification rule,
the profiling engine having the at least one classification rule includes tallying each visit to a website by the at least one mobile user to one of the plurality of classification groups based on a type of the website, and
the profiling engine having the at least one classification rule includes weighting behavior of the at least one mobile user over a period of time according to an algorithm taking into account a plurality of factors, where at least one of the plurality of factors includes previous acceptance rates of at least one of service offers and service subscriptions by the at least one mobile user.

10. The system of claim 1, wherein the offer manager is further configured to at least one of receive the at least one mobile user's response to the offered service and to send user and service information to the data collection system.

11. A method for targeted offers to at least one mobile user, comprising:
collecting information relating to the at least one mobile user's interests;
profiling the at least one mobile user according to a plurality of classification groups based on the collecting;
mapping the at least one mobile user profile received from the profiling to at least one service profile; and
offering at least one service to the at least one mobile user based on the mapping and a trigger received from the collecting.

12. The method of claim 11, wherein,
the collecting sends the trigger based on information relating to at least one of user acceptance probability, network load, and network signaling events, where the networking signaling events relate to at least one of powering on, attachment to a data network, and roaming, and
the collecting is further configured to collect information relating to an acceptance rate of the at least one service offered to the at least one mobile user.

13. The method of claim 12, wherein,
the offering offers the at least one service when the mobile user acceptance probability is high and the network load is low such that offering the service will not degrade performance of a network,
the offering determines the network load is low if a portion of the network that will carry service traffic has sufficient capacity for an additional mobile user, and
the offering determines the mobile user acceptance probability is high when the a least one mobile user is performing an activity related to the at least one service.

14. The method of claim 13, wherein the offering offers the at least one service at a another time period when the mobile user acceptance probability is high and the network load is low, if at least one of the network load is not low and the mobile user acceptance probability is not high at a current time period.

15. The method of claim 11, further comprising:
activating the at least one service if the at least one offered service is accepted by the at least one mobile user, requesting the at least one mobile user to subscribe to the at least one activated service for a fee after a trial time period expires, and
deactivating the at least one activated service if the at least one mobile user does not subscribe to the at least one activated service.

16. The method of claim 11, wherein the mapping pairs each of the at least one mobile users to the at least one of the services based on the at least one mobile user profiles and the at least one service profiles, where the at least one mobile user profiles indicate at least one mobile user's level of interest in one or more target areas and the at least one service profile indicates at least one service's compatibility to the one or more target areas.

17. The method of claim 11, further comprising:
analyzing data packets sent between the at least one mobile user and a public internet network to send information about the analyzed data packets to the collecting, wherein
the collecting collects information relating to at least one of web traces, web sites visited, keyword searches, a duration the websites are visited, a duration the services are accessed are visited, a duration the services are accessed, calling records, Call Detail Records (CDRs), and demographics information, and
the web traces are collected from the DPI, the CDRs are collected from at least one of the DPI and a billing system, and the demographics information is collected from an external database, with the CDRs including summary records describing the at least one mobile user's usage of network resources and the demographics information including at least one of subscriber age, gender and location of the at least one mobile user.

18. The method of claim 11, wherein the method is implemented to conduct market research for a new service, where the market research includes gauging at least one of user interest, pricing strategies, usage patterns, and an effect on the network of the new service, with the pricing strategies including offering a service contract at varying prices to the users.

19. The method of claim 11, wherein,
the profiling having the plurality of classification groups includes at least one of video, music, sports, news, and social networking groups,
the profiling classifies the received collected information according to one of the plurality of classification groups based on at least one classification rule,
the profiling having the at least one classification rule includes tallying each visit to a website by the at least one mobile user to one of the plurality of classification groups based on a type of the website, and
the profiling having the at least one classification rule includes weighting behavior of the at least one mobile user over a period of time according to an algorithm taking into account a plurality of factors, where at least one of the plurality of factors includes previous acceptance rates of at least one of service offers and service subscriptions by the at least one mobile user.

20. The method of claim 11, wherein the offering at least one of receives the at least one mobile user's response to the offered service and sends user and service information to the collecting.
